(19) United States
(12) Patent Application Publication
(10) Pub. No.: US 2024/0226808 A1
(43) Pub. Date: Jul. 11, 2024

(54) DETACHABLE CHEMICAL FILTERS

(71) Applicant: Samsung Electronics Co., Ltd., Suwon-si (KR)

(72) Inventors: Mira Park, Suwon-si (KR); Heonkyu Kim, Suwon-si (KR); Kieung Lee, Cheongju-si (KR); Hoigu Jang, Cheongju-si (KR); Jiyoung Kim, Suwon-si (KR); Jua Ryu, Suwon-si (KR); Sojung Park, Suwon-si (KR); Mingyeong Shin, Cheongju-si (KR); Jiwoong Shin, Suwon-si (KR); Jungsuk Oh, Cheongju-si (KR); Taijin Yoon, Cheongju-si (KR); Minseon Lee, Suwon-si (KR); Hyoyoung Lee, Cheongju-si (KR); Jinhong Kim, Cheongju-si (KR)

(73) Assignees: Samsung Electronics Co., Ltd., Suwon-si (KR); EcoPro HN Co., Ltd., Cheongju-si (KR)

(21) Appl. No.: 18/404,664

(22) Filed: Jan. 4, 2024

(30) Foreign Application Priority Data
Jan. 5, 2023 (KR) 10-2023-0001943
Mar. 24, 2023 (KR) 10-2023-0039265

(51) Int. Cl. B01D 53/82; B01D 53/04; B01J 20/02; B01J 20/04; B01J 20/16; B01J 20/20; B01J 20/28; B01J 20/32; B01J 39/04; B01J 39/18; B01J 41/04; B01J 41/12; B01J 47/024; B01J 47/026

(52) U.S. Cl. CPC B01D 53/82; B01D 53/0407; B01J 20/0259; B01J 20/04; B01J 20/16; B01J 20/20; B01J 20/28052; B01J 20/3204; B01J 20/324; B01J 39/04; B01J 39/18; B01J 41/04; B01J 41/12; B01J 47/024; B01J 47/026; B01D 2253/102; B01D 2253/108; B01D 2257/2045; B01D 2257/2047; B01D 2257/302; B01D 2257/404; B01D 2257/406; B01D 2257/708

(57) ABSTRACT

A chemical filter includes a first buffer layer, at least one first filter layer disposed on the first buffer layer and including a pair of first air-permeable bodies facing each other and at least one first adsorption layer between the pair of first air-permeable bodies, and a second filter layer disposed on the first filter layer and including a pair of second air-permeable bodies facing each other and at least one second adsorption layer between the pair of second air-permeable bodies, wherein the first filter layer is configured to be attachable to and detachable from the second filter layer.

### CROSS-REFERENCE TO RELATED APPLICATION

This application is based on and claims priority under 35 U.S.C. § 119 to Korean Patent Application No. 10-2023-0001943, filed on Jan. 5, 2023, and Korean Patent Application No. 10-2023-0039265, filed on Mar. 24, 2023, both in the Korean Intellectual Property Office, and the disclosure of each of which is incorporated by reference herein in its entirety.

### BACKGROUND

Aspects of the inventive concept relate to a chemical filter, and more particularly, to a chemical filter including filter layers that are independently attachable to and detachable from each other.

In the semiconductor manufacturing process and/or display manufacturing process, chemical contaminants, such as acidic gases (NOₓ, SOₓ, HCl, HF, organic acids, etc.), basic gases (NH₃, amines, etc.), organic sulfur compounds, and volatile organic compounds (VOCs), etc., may occur. Since these chemical contaminants can cause environmental pollution and damage the respiratory system and nervous system of the human body, it is important to remove them. In general, in order to remove chemical contaminants, a chemical filter including a plurality of adsorbents capable of removing various chemical contaminants is used in the semiconductor manufacturing process and/or the display manufacturing process. As the semiconductor manufacturing process and/or the display manufacturing process become larger, more chemical contaminants are generated and the size of the chemical filter for removing them is also increasing. When the plurality of adsorbents included in the chemical filter are integrally configured, economic efficiency deteriorates because the entire chemical filter must be replaced even when only some of the plurality of adsorbents break through, and it is not easy to move and install the chemical filter because the plurality of adsorbents must be moved and installed integrally.

### SUMMARY

Aspects of the inventive concept provide a chemical filter which is easy to move and install and has filter layers which are independently replaceable.

According to an aspect of the inventive concept, a chemical filter includes a first buffer layer, at least one first filter layer disposed on the first buffer layer and including a pair of first air-permeable bodies facing each other and at least one first adsorption layer between the pair of first air-permeable bodies, and a second filter layer disposed on the first filter layer and including a pair of second air-permeable bodies facing each other and at least one second adsorption layer between the pair of second air-permeable bodies. The first filter layer is configured to be attachable to and detachable from the second filter layer.

According to another aspect of the inventive concept, a chemical filter includes a first filter layer having a cylindrical shape and including a pair of first air-permeable bodies and at least one first adsorption layer between the pair of first air-permeable bodies, and at least one second filter layer surrounding the first filter layer and including a pair of second air-permeable bodies and at least one second adsorption layer between the pair of second air-permeable bodies. The first filter layer is configured to be attachable to and detachable from the second filter layer.

According to another aspect of the inventive concept, a chemical filter includes a first buffer layer, a first filter layer disposed on the first buffer layer and including a pair of first air-permeable bodies facing each other, and a first sub-adsorption layer and a second sub-adsorption layer which are sequentially arranged between the pair of first air-permeable bodies, and a second filter layer disposed on the first filter layer and including a pair of second air-permeable bodies facing each other, and a third sub-adsorption layer and a fourth sub-adsorption layer which are sequentially arranged between the pair of second air-permeable bodies The first filter layer is configured to be attachable to and detachable from the second filter layer as a first air-permeable body located higher among the pair of first air-permeable bodies is attached to or detached from a second air-permeable body positioned lower among the pair of second air-permeable bodies.

### BRIEF DESCRIPTION OF THE DRAWINGS

Embodiments will be more clearly understood from the following detailed description taken in conjunction with the accompanying drawings in which:

FIG. 1 is a perspective view of a chemical filter according to some embodiments;

FIG. 2 is a cross-sectional view of a first filter layer taken along line A-A′ in FIG. 1;

FIG. 3 is a cross-sectional view of a second filter layer taken along line A-A′ in FIG. 1;

FIG. 4 is a perspective view of a chemical filter according to some embodiments;

FIG. 5 is a cross-sectional view of a first filter layer taken along line B-B′ in FIG. 4;

FIG. 6 is a perspective view of a chemical filter according to some embodiments;

FIG. 7 is a perspective view of a chemical filter according to some embodiments;

FIG. 8 is a plan view of a chemical filter at a first vertical level in FIG. 7; and

FIG. 9 is a perspective view of a chemical filter according to some embodiments.

### DETAILED DESCRIPTION

Embodiments will now be described in detail with reference to the accompanying drawings. The same reference numerals are used for the same components in the drawings, and overlapping descriptions thereof are omitted.

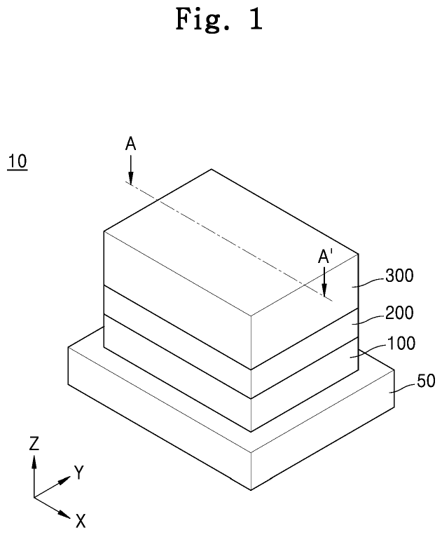

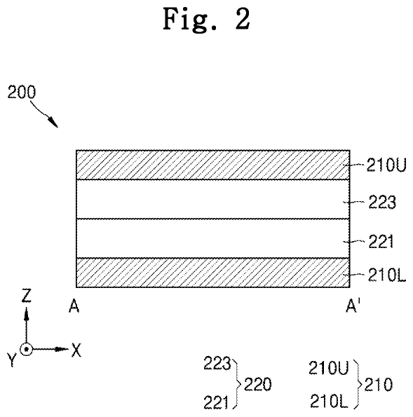

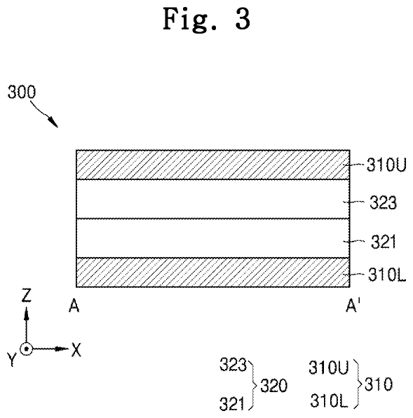

FIG. 1 is a perspective view of a chemical filter 10 according to some embodiments. FIG. 2 is a cross-sectional view of a first filter layer 200 taken along line A-A′ in FIG. 1. FIG. 3 is a cross-sectional view of a second filter layer 300 taken along line A-A′ in FIG. 1.

Referring to FIGS. 1-3, the chemical filter 10 may be attached onto an air moving member 50. The air moving member 50 may be or include, e.g., a fan filter unit (FFU), but is not limited thereto. The chemical filter 10 may remove chemical contaminants contained in the outside air and provide the outside air from which the chemical contaminants have been removed to the air moving member 50. The chemical contaminants may include, e.g., acidic gases (NOₓ, SOₓ, HCl, HF, organic acids, etc.), basic gases (NH₃, amines, etc.), and volatile organic compounds (VOCs). The outside air provided from the chemical filter 10 to the air moving member 50 may be provided to a clean room in a semiconductor manufacturing process and/or a display manufacturing process through the air moving member 50.

The chemical filter 10 may include a first buffer layer 100, a first filter layer 200, and a second filter layer 300.

The first buffer layer 100 may be disposed on the air moving member 50, for example, to be directly adjacent to the air moving member 50. Since the chemical filter 10 includes the first buffer layer 100, the bonding force between the chemical filter 10 and the air moving member 50 may be enhanced. In some embodiments, the first buffer layer 100 may have a void therein. The void of the first buffer layer 100 may receive the outside air sequentially processed by the second filter layer 300 and the first filter layer 200 to provide the outside air to the air moving member 50. In some embodiments, the first buffer layer 100 may include at least one of stainless steel (SUS) and aluminum. The first buffer layer 100 may have a frame shape, for example, to have four sides that form an external frame, with a space in a region inside the four sides (from a plan view). A bottom of the first buffer layer 100 may connect to the air moving member 50, and a top of the first buffer layer 100 may contact the first filter layer 200. In some embodiments, the first buffer layer 100 may have a vertical length, also described as a thickness, of about 110 mm to about 150 mm in a vertical direction (Z direction). When the vertical length of the first buffer layer 100 is 110 mm or less, or 150 mm or more, the outside air may not flow well into the chemical filter 10.

The first filter layer 200 may be disposed on the first buffer layer 100. The first filter layer 200 may remove the acidic gases and the basic gases contained in the outside air. The first filter layer 200 may include a pair of first air-permeable bodies 210, and a first adsorption layer 220 arranged between the pair of first air-permeable bodies 210.

The pair of first air-permeable bodies 210 may include a first sub-air-permeable body 210L and a second sub-air-permeable body 210U. The first sub-air-permeable body 210L may refer to a first air-permeable body 210 located relatively lower among the pair of first air-permeable bodies 210, and the second sub-air-permeable body 210U may refer to a first air-permeable body 210 located relatively higher among the pair of first air-permeable bodies 210. The first sub-air-permeable body 210L may face the second sub-air-permeable body 210U in the vertical direction (Z direction). The term “sub-” as used here is simply a name differentiator, used to differentiate different components from each other.

The pair of first air-permeable bodies 210 may include a material having gas permeability. Thus, the outside air treated by the second filter layer 300 may pass through the pair of first air-permeable bodies 210, and may be absorbed or adsorbed by the first adsorption layer 220.

The pair of first air-permeable bodies 210 may secure (e.g., protect and hold in place) the first adsorption layer 220. For example, the first sub-air-permeable body 210L may secure (e.g., protect and hold in place) a first sub-adsorption layer 221, and the second sub-air-permeable body 210U may secure (e.g., protect and hold in place) a second sub-adsorption layer 223. The impact resistance and durability of the first filter layer 200 may be improved as the first sub-air-permeable body 210L secures the first sub-adsorption layer 221, and the second sub-air-permeable body 210U secures the second sub-adsorption layer 223.

In some embodiments, the pair of first air-permeable bodies 210 may have a corrugated surface. For example, a top surface of the first sub-air-permeable body 210L and a bottom surface of the second sub-air-permeable body 210U may have a corrugated shape.

In some embodiments, the pair of first air-permeable bodies 210 may include a non-woven fabric. When the pair of first air-permeable bodies 210 include a non-woven fabric, the first adsorption layer 220 may be better supported by the pair of first air-permeable bodies 210, and the gas permeability of the pair of first air-permeable bodies 210 may be improved. Accordingly, the durability and pollutant removal performance of the first filter layer 200 may be improved.

The first adsorption layer 220 may include the first sub-adsorption layer 221 and the second sub-adsorption layer 223 that are sequentially stacked on the first sub-air-permeable body 210L. The first adsorption layer 220 may remove the acidic gases and the basic gases contained in the outside air.

The first sub-adsorption layer 221 may adsorb and remove the basic gases contained in the outside air. The first sub-adsorption layer 221 may be described as a basic gas removal layer. In some embodiments, the first sub-adsorption layer 221 may include or be formed of at least one of activated carbon supported with phosphorus-based compounds, and cation exchange resin. The phosphorus-based compounds may include or be a phosphoric acid-derived compound. For example, the phosphorus-based compounds may include or be at least one selected from the group consisting of phosphoric acid, metaphosphoric acid, and polyphosphoric acid. The cation exchange resin may include, e.g., hydrogen ions (H⁺) as a functional group. Accordingly, hydrogen ions (H⁺) of the cation exchange resin may be exchanged with cations of the basic gases to remove harmful effects of the basic gases.

The second sub-adsorption layer 223 may adsorb and remove the acidic gases contained in the outside air. The second sub-adsorption layer 223 may be described as a acidic gas removal layer. In some embodiments, the second sub-adsorption layer 223 may include or be formed of at least one of activated carbon supported with potassium-based compounds or sodium-based compounds, and anion exchange resin. The potassium-based compounds may include or be, e.g., at least one selected from the group consisting of KI, KOH, and K₂CO₃, and the sodium-based compounds may include or be, e.g., at least one selected from the group consisting of NaOH and Na₂CO₃. The anion exchange resin may include, e.g., hydroxide ions (OH⁻) as a functional group. Thus, the hydroxide ions (OH⁻) may be exchanged with anions of the acidic gases to remove the harmful effects of the acidic gases.

The second filter layer 300 may be disposed on the first filter layer 200. The second filter layer 300 may remove volatile organic compounds contained in the outside air. The second filter layer 300 may be the outermost layer, and may contact outside air. Thus, the outside air may be introduced into the second filter layer 300, and may be treated primarily by the second filter layer 300.

The second filter layer 300 may include a pair of second air-permeable bodies 310, and a second adsorption layer 320 arranged between the pair of second air-permeable bodies 310.

The pair of second air-permeable bodies 310 may include a third sub-air-permeable body 310L and a fourth sub-air-permeable body 310U. The third sub-air-permeable body 310L may refer to a second air-permeable body 310 located relatively lower among the pair of second air-permeable bodies 310, and the fourth sub-air-permeable body 310U may refer a second air-permeable body 310 located relatively higher among the pair of second air-permeable bodies 310. The third sub-air-permeable body 310L may face the fourth sub-air-permeable body 310U in the vertical direction (Z direction). Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

The pair of second air-permeable bodies 310 may include or be formed of a material having air permeability. Thus, the outside air may pass through the pair of second air-permeable bodies 310, and may be absorbed or adsorbed by the second adsorption layer 320.

The pair of second air-permeable bodies 310 may secure the second (e.g., protect and hold in place) adsorption layer 320. For example, the third sub-air-permeable body 310L may secure (e.g., protect and hold in place) a third sub-adsorption layer 321, and the fourth sub-air-permeable body 310U may secure (e.g., protect and hold in place) a fourth sub-adsorption layer 323. The impact resistance and durability of the second filter layer 300 may be improved as the third sub-air-permeable body 310L secures the third sub-adsorption layer 321, and the fourth sub-air-permeable body 310U secures the fourth sub-adsorption layer 323.

In some embodiments, the pair of second air-permeable bodies 310 may have a corrugated surface. For example, a top surface of the third sub-air-permeable body 310L and a bottom surface of the fourth sub-air-permeable body 310U may have a corrugated shape.

In some embodiments, the pair of second air-permeable bodies 310 may include a non-woven fabric, such as an air-permeable synthetic polymer. When the pair of second air-permeable bodies 310 include a non-woven fabric, the second adsorption layer 320 may be better supported by the pair of second air-permeable bodies 310, and the gas permeability of the pair of second air-permeable bodies 310 may be improved. Accordingly, the durability and pollutant removal performance of the second filter layer 300 may be improved.

The second adsorption layer 320 may include the third sub-adsorption layer 321 and the fourth sub-adsorption layer 323 that are sequentially stacked on the third air-permeable body 310L. The second adsorption layer 320 may remove volatile organic compounds contained in the outside air.

The third sub-adsorption layer 321 and the fourth sub-adsorption layer 323 may adsorb and remove the volatile organic compounds contained in the outside air. In some embodiments, the third sub-adsorption layer 321 may include or be formed of at least one of activated carbon and zeolite. The activated carbon may be, e.g., non-impregnated activated carbon to which no chemical is impregnated. In some embodiments, the fourth sub-adsorption layer 323 may include or be formed of surface-modified activated carbon. When the fourth sub-adsorption layer 323 includes surface-modified activated carbon, the specific surface area of the activated carbon increases, and the volatile organic compound removal performance of the second filter layer 300 may be improved.

In some embodiments, the first filter layer 200 may be configured to be attachable to and detachable from the second filter layer 300. For example, as the second sub-air-permeable body 210U of the first filter layer 200 is attached to or detached from the third sub-air-permeable body 310L of the second filter layer 300, the first filter layer 200 may be attachable to or detachable from the second filter layer 300.

In some embodiments, the first buffer layer 100, the first filter layer 200, and the second filter layer 300 may together have a plate shape. For example, the first buffer layer 100, the first filter layer 200, and the second filter layer 300 may have a plate shape in which a vertical direction (Z direction) length, a first horizontal direction (X direction) length, and a second horizontal direction (Y direction) length are the same (e.g., this may form a cube shape).

In some embodiments, the chemical filter 10 may further include a first case (not shown) receiving the first filter layer 200 and a second case (not shown) receiving the second filter layer 300. For example, the first case and the second case may have a rectangular parallelepiped shape with an opening in the center. The first filter layer 200 may be disposed within the opening of the first case, and the second filter layer 300 may be disposed within the opening of the second case. According to some embodiments, the first case and the second case have the same horizontal area. When the chemical filter 10 includes the first case and the second case, the first filter layer 200 and the second filter layer 300 may be easily transported and replaced. In one embodiment, the different cases can be attachable and detachable from each other, for example by using a set of grooves, clips, or other fasteners.

According to some embodiments, the chemical filter 10 includes the first buffer layer 100, the first filter layer 200 disposed on the first buffer layers 100, and the second filter layer 300 disposed on first filter layer 200, wherein the first filter layer 200 is configured to be attachable to and detachable from the second filter layer 300. For example, the second case receiving the second filter layer 300 may be stacked on top of the first case receiving the first filter layer 200, so that the first filter layer 200 and the second filter layer 300 may be attached to each other. The attachment and detachment may occur based on cases as discussed above, or based on the materials in the filters forming an adhesive connection at their interface (e.g., due to the carbon structure and nonwoven fabric structure of the materials that form the filter layers). Accordingly, if one of the first filter layer 200 and the second filter layer 300 breaks first, only the broken filter layer among the first filter layer 200 and the second filter layer 300 may be detached and replaced. As a result, the replacement cycle of the chemical filter 10 may be extended to improve the economic efficiency of semiconductor manufacturing infrastructure operation. In addition, since the first filter layer 200 and the second filter layer 300 may be conveyed and installed separately, the chemical filter 10 may be easily moved and installed.

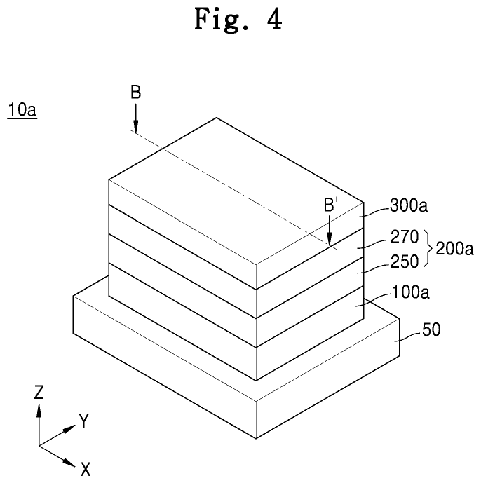

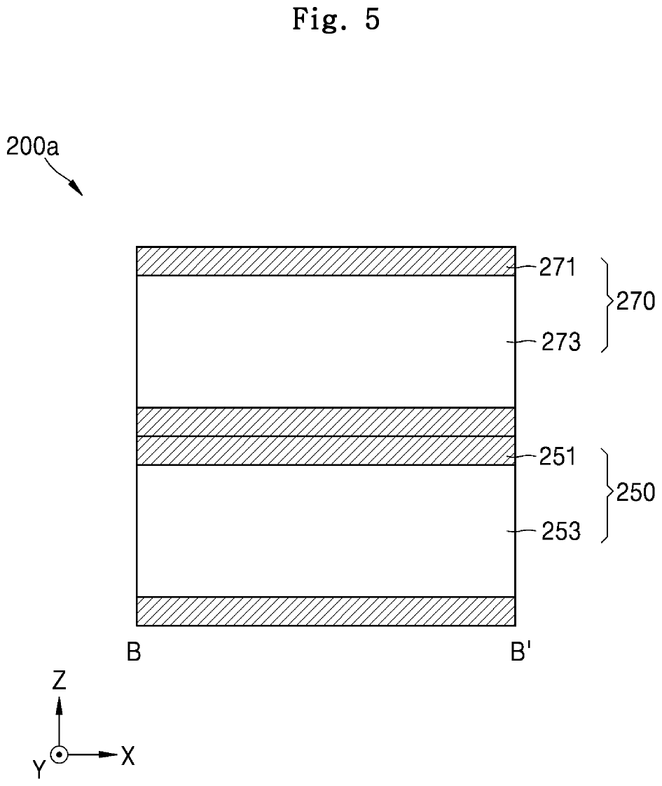

FIG. 4 is a perspective view of a chemical filter 10a according to some embodiments. FIG. 5 is a cross-sectional view of a first filter layer 200a taken along line B-B′ in FIG. 4. Since each component of the chemical filter 10a shown in FIGS. 4 and 5 is similar to each component of the chemical filter 10 described with reference to FIGS. 1 to 3, hereinafter, differences are mainly described.

Referring to FIGS. 4 and 5, the chemical filter 10a may include a first buffer layer 100a, a first filter layer 200a, and a second filter layer 300a.

The first buffer layer 100a may be disposed on the air moving member 50. The first buffer layer 100a may be substantially the same as or similar to the first buffer layer 100 described with reference to FIGS. 1 to 3.

The first filter layer 200a may include a first lower filter layer 250 and a first upper filter layer 270 which are sequentially arranged on the first buffer layer 100a.

The first lower filter layer 250 may include a pair of first lower air-permeable bodies 251 and a first lower adsorption layer 253 arranged between the pair of first lower air-permeable bodies 251.

The pair of first lower air-permeable bodies 251 may face each other in the vertical direction (Z direction). The pair of first lower air-permeable bodies 251 may secure the first lower adsorption layer 253. The pair of first lower air-permeable bodies 251 may be substantially the same as or similar to the pair of first air-permeable bodies 210 described with reference to FIGS. 1 to 3.

The first lower adsorption layer 253 may adsorb and remove the basic gases contained in the outside air. In an embodiment, the first lower adsorption layer 253 may include or be formed of at least one of activated carbon supported with phosphorus-based compounds, and cation exchange resin. The phosphorus-based compounds may include or be a phosphoric acid-derived compound. For example, the phosphorus-based compounds may include or be at least one selected from the group consisting of phosphoric acid, metaphosphoric acid, and polyphosphoric acid. The cation exchange resin may include, e.g., hydrogen ions (H⁺) as a functional group.

The first upper filter layer 270 may include a pair of first upper air-permeable bodies 271 and a first upper adsorption layer 273 arranged between the pair of first upper air-permeable bodies 271.

The pair of first upper air-permeable bodies 271 may face each other in the vertical direction (Z direction). The pair of first upper air-permeable bodies 271 may secure the first upper adsorption layer 273. A first upper air-permeable body 271 located relatively lower among the pair of first upper air-permeable bodies 271 may contact a first lower air-permeable body 251 located relatively higher among the pair of first lower air-permeable bodies 251. The pair of first upper air-permeable bodies 271 may be substantially the same as or similar to the pair of first air-permeable bodies 210 described with reference to FIGS. 1 to 3.

The first upper adsorption layer 273 may adsorb and remove the acidic gases contained in the outside air. In an embodiment, the first upper adsorption layer 273 may include or be formed of at least one of activated carbon supported with potassium-based compounds or sodium-based compounds, and anion exchange resin. The potassium-based compounds may include or be, e.g., at least one selected from the group consisting of KI, KOH, and K₂CO₃, and the sodium-based compounds may include or be, e.g., at least one selected from the group consisting of NaOH and Na₂CO₃. The anion exchange resin may include, e.g., hydroxide ions (OH⁻) as a functional group.

The second filter layer 300a may be disposed on the first filter layer 200a. The second filter layer 300a may include substantially the same or similar material as the second filter layer 300 described with reference to FIGS. 1 to 3, and may have a structure substantially the same as or similar to the second filter layer 300.

In an embodiment, the first lower filter layer 250 may be configured to be attachable to and detachable from the first upper filter layer 270, for example, in a manner similar to that discussed in connection with FIGS. 1 to 3. For example, as a first upper air-permeable body 271 located relatively lower among the pair of first upper air-permeable bodies 271 is attached to or detached from the first lower air-permeable body 251 positioned higher among the pair of first lower air-permeable bodies 251, the first lower filter layer 250 may be configured to be attachable to and detachable from the first upper filter layer 270.

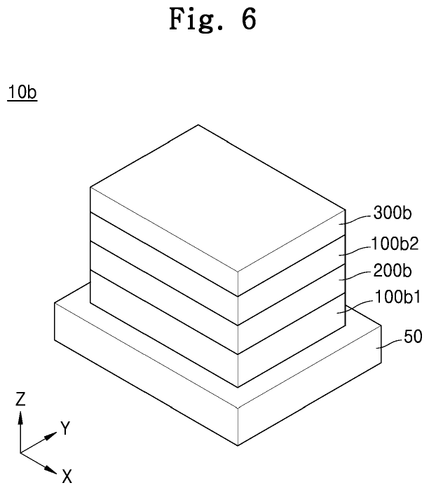

FIG. 6 is a perspective view of a chemical filter 10b according to some embodiments. Since each component of the chemical filter 10b shown in FIG. 6 is similar to each component of the chemical filter 10 described with reference to FIGS. 1 to 3, hereinafter, differences are mainly described.

Referring to FIG. 6, the chemical filter 10b may include a first buffer layer 100b1, a first filter layer 200b, a second buffer layer 100b2, and a second filter layer 300b.

The first buffer layer 100b may be disposed on the air moving member 50. The first buffer layer 100b may be substantially the same as or similar to the first buffer layer 100 described with reference to FIGS. 1 to 3.

The first filter layer 200b may be disposed on the first buffer layer 100b1. In some embodiments, the first filter layer 200b may be substantially the same as or similar to the first filter layer 200 described with reference to FIGS. 1 to 3. In some embodiments, the first filter layer 200b may be substantially the same as or similar to the first filter layer 200a described with reference to FIGS. 4 and 5.

The second filter layer 300b may be disposed on the second buffer layer 100b2. In some embodiments, the second filter layer 300b may be substantially the same as or similar to the second filter layer 300 described with reference to FIGS. 1 to 3.

The second buffer layer 100b2 may be arranged between the first filter layer 200b and the second filter layer 300b. The first buffer layer 100b2 may be substantially the same as or similar to the first buffer layer 100 described with reference to FIGS. 2 to 3. When the second buffer layer 100b2 is arranged between the first filter layer 200b and the second filter layer 300b, the physical impact applied to the first filter layer 200b and the second filter layer 300b may be alleviated to improve the stability of the chemical filter 10b.

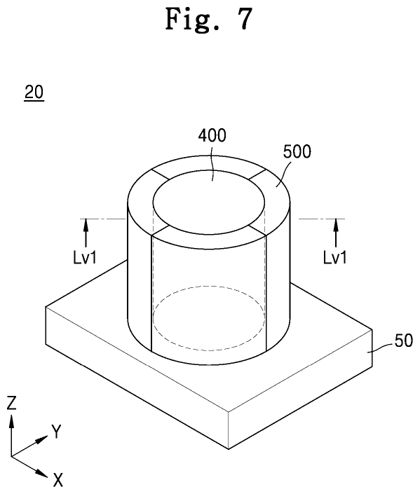

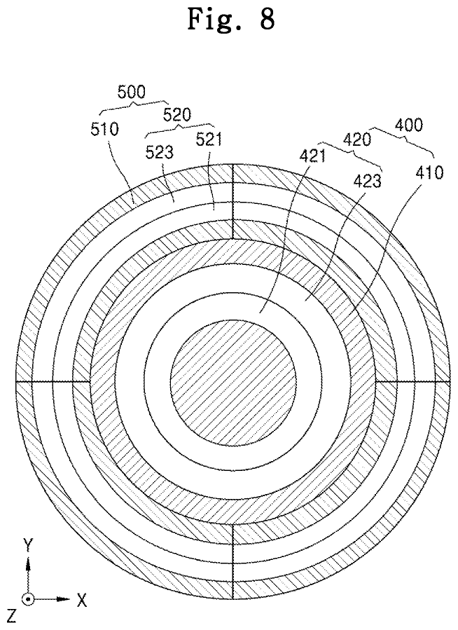

FIG. 7 is a perspective view of a chemical filter according to some embodiments. FIG. 8 is a plan view of a chemical filter at a first vertical level LV1 in FIG. 7.

Referring to FIGS. 7 and 8, the chemical filter 20 may be attached onto the air moving member 50. In some embodiments, the chemical filter 20 may generally have a cylindrical shape. The cylindrical shape may include a flat surface that connects to and is directly adjacent to the air moving member 50, and a curved surface perpendicular to the flat surface. The curved surface may form a circular shape from a plan view, as one example. For example, the chemical filter 20 may include a first filter layer 400 having a cylindrical shape and a second filter layer 500 surrounding the first filter layer 400, wherein the first filter layer 400 and the second filter layer 500 may both have a cylindrical shape.

The chemical filter 20 may include the first filter layer 400 and the second filter layer 500.

The first filter layer 400 may have a cylindrical shape. The first filter layer 400 may remove acidic gases and basic gases contained in the air that has passed through the second filter layer 500 from the outside. The first filter layer 400 may include a pair of first air-permeable bodies 410, and a first adsorption layer 420 arranged between the pair of first air-permeable bodies 410.

The pair of first air-permeable bodies 410 may be disposed outside and inside the circle in plan view. A first air-permeable body 410 located relatively outside among the pair of first air-permeable bodies 410 may contact a second air-permeable body 510 located relatively inside among the pair of second air-permeable bodies 510, and a first air-permeable body 410 located relatively inside among the pair of first air-permeable bodies 410 may contact a first sub-adsorption layer 421. The pair of first air-permeable bodies 410 may secure the first adsorption layer 420. The pair of first air-permeable bodies 410 may be substantially the same as or similar to the pair of first air-permeable bodies 210 described with reference to FIGS. 1 to 3.

The first adsorption layer 420 may be arranged between the pair of first air-permeable bodies 410 in plan view. The first adsorption layer 420 may adsorb and remove the acidic gases and the basic gases contained in the air that has passed through the second filter layer 500 from the outside. The first adsorption layer 420 may include the first sub-adsorption layer 421 and a second sub-adsorption layer 423. The first sub-adsorption layer 421 may surround a first air-permeable body 410 located relatively inside among the pair of first air-permeable bodies 410 in plan view, and the second sub-adsorption layer 423 may surround the first sub-adsorption layer 421 in plan view. The first sub-adsorption layer 421 may be substantially the same as or similar to the first sub-adsorption layer 221 described with reference to FIGS. 1 to 3 in terms of materials, and the second sub-adsorption layer 423 may be substantially the same as or similar to the second sub-adsorption layer 223 described with reference to FIGS. 1 to 3 in terms of materials.

A cover layer (not shown) capable of blocking the inflow of outside air may be disposed on a top surface of the first filter layer 400. The cover layer 400 may include or be formed of a metal, such as aluminum. The outside air may not flow into the first filter layer 400 due to the cover layer, and only air that has passed through the second filter layer 500 may flow into the first filter layer 400.

The second filter layer 500 may surround the first filter layer 400. The second filter layer 500 may have a cylindrical shape with a void in the center, and the void may be filled with the first filter layer 400. The second filter layer 500 may remove volatile organic compounds contained in the outside air.

The second filter layer 500 may include a pair of second air-permeable bodies 510, and a second adsorption layer 520 arranged between the pair of second air-permeable bodies 510.

A second air-permeable body 510 located relatively inside among the pair of second air-permeable bodies 510 may contact a first air-permeable body 410 located relatively outside among the pair of first air-permeable bodies 410, and a second air-permeable body 510 located relatively outside among the pair of second air-permeable bodies 510 may contact the outside air. The pair of second air-permeable bodies 510 may secure the second adsorption layer 520. The pair of second air-permeable bodies 510 may be substantially the same as or similar to the pair of second air-permeable bodies 310 described with reference to FIGS. 1 to 3.

The second adsorption layer 520 may adsorb and remove volatile organic compounds contained in the outside air. The second adsorption layer 520 may include a third sub-adsorption layer 521 and a fourth sub-adsorption layer 523. The third sub-adsorption layer 521 may surround a second air-permeable body 510 located relatively inside among the pair of second air-permeable bodies 510 in plan view, and the fourth sub-adsorption layer 523 may surround the third sub-adsorption layer 521 in plan view. The third sub-adsorption layer 521 may be substantially the same as or similar to the third sub-adsorption layer 321 described with reference to FIGS. 1 to 3. The fourth sub-adsorption layer 523 may be substantially the same as or similar to the fourth sub-adsorption layer 323 described with reference to FIGS. 1 to 3. A cover layer (not shown) capable of blocking the outflow of air may be disposed on a bottom surface of the second filter layer 500. The air may not flow out of the second filter layer 500 at a bottom surface due to the cover layer, and therefore only air that has passed through the second filter layer 500 as well as the first filter layer 400 may pass through the air moving unit 50. In some embodiments, the bottom cover may additionally cover an outer air-permeable body 410, so that all air must pass through to the inner air-permeable body 410 in order to be output from the air moving member 50.

In some embodiments, the top surface of the first filter layer 400 and the top surface of the second filter layer 500 may be located at the same vertical level.

In some embodiments, the second filter layer 500 may include a plurality of sub-filter portions. The plurality of sub-filter portions may have the same shape (e.g., each may be a quarter of the cylinder, or some other percentage of the cylinder divided in a radial manner). In some embodiments, the number of the plurality of sub-filter portions may be between about 2 and about 6. When the number of the plurality of sub-filter portions is 1 or more than 6, the structural stability of the chemical filter 20 may deteriorate. In some embodiments, the plurality of sub-filter portions may be configured to be attachable to or detachable from each other. For example, the plurality of sub-filter portions may be attached to each other by being arranged around the first filter layer 400 and surrounding the outer surface of the first filter layer 400, wherein the material at the outer surface of the first filter layer 400 is formed to detachably adhere to the material at the inner surface of the plurality of sub-filter portions. Since the plurality of sub-filter portions are attachable to or detachable from each other, when only some of the plurality of sub-filter portions are broken, only the broken sub-filter portions among the plurality of sub-filter portions may be individually detached and replaced without replacing the entire chemical filter 20. As a result, the replacement cycle of the chemical filter 20 may be extended to improve the economic efficiency of semiconductor manufacturing infrastructure operation. In addition, since it is possible to transport and install the plurality of sub-filter portions separately, the chemical filter 20 may be moved and installed easily.

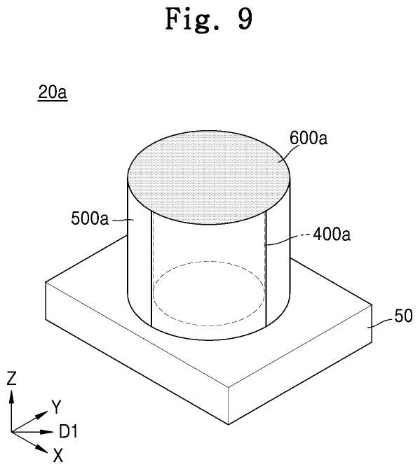

FIG. 9 is a perspective view of a chemical filter 20a according to some embodiments. Since each component of the chemical filter 20a shown in FIG. 9 is similar to each component of the chemical filter 20 described with reference to FIGS. 7 and 8, hereinafter, differences are mainly described.

Referring to FIG. 9, the chemical filter 20a may include a first filter layer 400a, a second filter layer 500a, and a cover layer 600a.

The first filter layer 400a may be inside of and surrounded by the second filter layer 500a. The first filter layer 400a may remove acidic gases and basic gases contained in the outside air. The first filter layer 400a may be substantially the same as or similar to the first filter layer 400 described with reference to FIGS. 7 and 8.

The second filter layer 500a may remove volatile organic compounds contained in the outside air. The second filter layer 500a may be substantially the same as or similar to the second filter layer 500 described with reference to FIGS. 7 and 8.

The cover layer 600a may be disposed on the first filter layer 400a and the second filter layer 500a. The cover layer 600a may have a disk shape. As the cover layer 600a covers a top surface of the first filter layer 400a and a top surface of the second filter layer 500a, the outside air flowing into the sidewall of the chemical filter 20b (i.e., the sidewall of the second filter layer 500a) may not flow out through the top surface of the first filter layer 400a and the top surface of the second filter layer 500a, and may be sequentially processed by the second filter layer 500a and the first filter layer 400a to be provided to the air moving member 50. A bottom cover, such as described in connection with FIG. 8 may also be used. Accordingly, performance of removing contaminants contained in the outside air and performance of supplying air to the air moving member 50 of the chemical filter 20b may be improved.

While the inventive concept has been particularly shown and described with reference to embodiments thereof, it will be understood that various changes in form and details may be made therein without departing from the spirit and scope of the following claims.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, or as “contacting” or “in contact with” another element (or using any form of the word “contact”), there are no intervening elements present at the point of contact. Other words used to describe the relationship between elements should be interpreted in a like fashion (e.g., “between” versus “directly between,” “adjacent” versus “directly adjacent,” etc.).

What is claimed is:

1. A chemical filter comprising:
a first buffer layer;
at least one first filter layer disposed on the first buffer layer and including a pair of first air-permeable bodies facing each other and at least one first adsorption layer between the pair of first air-permeable bodies; and
a second filter layer disposed on the first filter layer and including a pair of second air-permeable bodies facing each other and at least one second adsorption layer between the pair of second air-permeable bodies,
wherein the first filter layer is configured to be attachable to and detachable from the second filter layer.

2. The chemical filter of claim 1,
wherein the first buffer layer has a void therein and includes at least one of stainless steel (SUS) and aluminum.

3. The chemical filter of claim 1,
wherein the at least one first adsorption layer includes a first sub-adsorption layer disposed on a first air-permeable body located relatively lower among the pair of first air-permeable bodies and a second sub-adsorption layer disposed on the first sub-adsorption layer,
the first sub-adsorption layer comprises at least one of activated carbon supported with phosphorus-based compounds, and cation exchange resin, and
the second sub-adsorption layer comprises at least one of activated carbon supported with potassium-based compounds or sodium-based compounds, and anion exchange resin.

4. The chemical filter of claim 3,
wherein the cation exchange resin contains hydrogen ions (H⁺) as a functional group, and
the anion exchange resin contains hydroxide ions (OH⁻) as a functional group.

5. The chemical filter of claim 3,
wherein the phosphorus-based compounds include at least one selected from the group consisting of phosphoric acid, metaphosphoric acid, and polyphosphoric acid,
the potassium-based compounds include at least one selected from the group consisting of KI, KOH, and K₂CO₃, and
the sodium-based compounds include at least one selected from the group consisting of NaOH and Na₂CO₃.

6. The chemical filter of claim 1,
wherein the at least one second adsorption layer includes a first sub-adsorption layer disposed on a second air-permeable body located relatively lower among the pair of second air-permeable bodies and a second sub-adsorption layer disposed on the first sub-adsorption layer,
the first sub-adsorption layer comprises at least one of activated carbon and zeolite, and
the second sub-adsorption layer comprises surface-modified activated carbon.

7. The chemical filter of claim 1, further comprising:
a second buffer layer between the first filter layer and the second filter layer.

8. The chemical filter of claim 1,
wherein the first filter layer comprises a first lower filter layer disposed on the first buffer layer and a first upper filter layer disposed on the first lower filter layer,
the first lower filter layer comprises a pair of first lower air-permeable bodies facing each other and a first lower adsorption layer between the pair of first lower air-permeable bodies, and
the first upper filter layer comprises a pair of first upper air-permeable bodies facing each other and a first upper adsorption layer between the pair of first upper air-permeable bodies.

9. The chemical filter of claim 8,
wherein the first lower adsorption layer comprises at least one of activated carbon supported with phosphorus-based compounds, and cation exchange resin, and
the first upper adsorption layer comprises at least one of activated carbon supported with potassium-based compounds or sodium-based compounds, and anion exchange resin.

10. The chemical filter of claim 8,
wherein the first lower filter layer is configured to be attachable to and detachable from the first upper filter layer.

11. The chemical filter of claim 1,
wherein the first filter layer and the second filter layer each have a plate shape.

12. A chemical filter comprising: a first filter layer having a cylindrical shape and including a pair of first air-permeable bodies and at least one first adsorption layer between the pair of first air-permeable bodies; and
at least one second filter layer surrounding the first filter layer and including a pair of second air-permeable bodies and at least one second adsorption layer between the pair of second air-permeable bodies,
wherein the first filter layer is configured to be attachable to and detachable from the second filter layer.

13. The chemical filter of claim 12,
wherein the second filter layer includes a plurality of sub-filter layers, and the plurality of sub-filter layers have the same shape.

14. The chemical filter of claim 13,
wherein a total number of the plurality of sub-filter layers within a range from 2 to 6.

15. The chemical filter of claim 13,
wherein the plurality of sub-filter layers are configured to be attachable to and detachable from each other.

16. The chemical filter of claim 12, further comprising:
a cover layer covering a top surface of the first filter layer and a top surface of the second filter layer.

17. The chemical filter of claim 12,
wherein the at least one first adsorption layer comprises a first sub-adsorption layer in contact with a first air-permeable body located relatively inside among the pair of first air-permeable bodies, and a second sub-adsorption layer in contact with a first air-permeable body located relatively outside among the pair of first air-permeable bodies,
the first sub-adsorption layer comprises at least one of activated carbon supported with phosphorus-based compounds, and cation exchange resin, and the second sub-adsorption layer comprises at least one of activated carbon supported with potassium-based compounds or sodium-based compounds, and anion exchange resin,
the at least one second adsorption layer includes a third sub-adsorption layer in contact with a second air-permeable body located relatively inside among the pair of second air-permeable bodies, and a fourth sub-adsorption layer in contact with a second air-permeable body located relatively outside among the pair of second air-permeable bodies, and
the third sub-adsorption layer comprises at least one of activated carbon and zeolite, and the fourth sub-adsorption layer comprises surface-modified activated carbon.

18. A chemical filter comprising:
a first buffer layer;
a first filter layer disposed on the first buffer layer and including a pair of first air-permeable bodies facing each other, and a first sub-adsorption layer and a second sub-adsorption layer which are sequentially arranged between the pair of first air-permeable bodies; and
a second filter layer disposed on the first filter layer and including a pair of second air-permeable bodies facing each other, and a third sub-adsorption layer and a fourth sub-adsorption layer which are sequentially arranged between the pair of second air-permeable bodies,
wherein the first filter layer is configured to be attachable to and detachable from the second filter layer as a first air-permeable body located higher among the pair of first air-permeable bodies is attached to or detached from a second air-permeable body positioned lower among the pair of second air-permeable bodies.

19. The chemical filter of claim 18,
wherein the first sub-adsorption layer comprises at least one of activated carbon supported with phosphorus-based compounds, and cation exchange resin, the second sub-adsorption layer comprises at least one of activated carbon supported with potassium-based compounds or sodium-based compounds, and anion exchange resin, the third sub-adsorption layer comprises at least one of activated carbon and zeolite, and the fourth sub-adsorption layer comprises surface-modified activated carbon.

20. The chemical filter of claim 18,
wherein the first filter layer and the second filter layer have a plate shape.
